(19) United States
(12) Patent Application Publication
(10) Pub. No.: US 2026/0109506 A1
(43) Pub. Date: Apr. 23, 2026

(54) CONTAINER OPENER SYSTEM AND METHOD

(71) Applicant: DESIGN & ASSEMBLY CONCEPTS, INC., LEANDER, TX (US)

(72) Inventors: Dillon E. GANNINGER, Georgetown, TX (US); Mark E. GANNINGER, Leander, TX (US)

(21) Appl. No.: 19/360,657

(22) Filed: Oct. 16, 2025

Related U.S. Application Data
(60) Provisional application No. 63/708,543, filed on Oct. 17, 2024.

(51) Int. Cl. B65B 69/00; B25J 15/00

(52) U.S. Cl. CPC B65B 69/0025; B25J 15/0019

(57) ABSTRACT

A container opener system can include a cutter head with an actuator to selectively extend and retract a blade, and an actuator to resiliently bias the cutter head into contact with a container component, and an actuator mount that connects the cutter head to another actuator. A method can include mounting a cutter head for displacement relative to a container, the cutter head comprising an actuator that selectively extends and retracts a blade, operating the actuator, thereby extending the blade outward, and displacing the cutter head along a container component, thereby cutting through the component. Another actuator resiliently biases the blade toward the component during the cutting. A blade handling assembly can include a blade dispenser having an actuator, a blade guide assembly, and a blade magazine containing multiple blades. The blade guide assembly discharges a blade from the blade magazine in response to actuation of the actuator.

### CROSS-REFERENCE TO RELATED APPLICATION

This application claims the benefit of the filing date of U.S. provisional application No. 63/708,543 filed on 17 Oct. 2024. The entire disclosure of the prior application is incorporated herein by this reference for all purposes.

### BACKGROUND

This disclosure relates generally to equipment utilized and operations performed in conjunction with product transport, handling and distribution operations and, in an example described below, more particularly provides a container opener system and associated methods.

Many products are packed and shipped in containers, such as corrugated cardboard boxes. It is frequently desired to open the containers, for example, at a storage or distribution facility.

However, opening containers can involve use of sharp cutting implements, and so it would be desirable for safety reasons to reduce or eliminate handling or use of such cutting implements by humans at the facility. In addition, it would be desirable to perform the container opening operation efficiently and effectively.

Therefore, it will be readily appreciated that improvements are continually needed in the art of constructing and operating container opener systems. The present disclosure provides such improvements to the art.

### BRIEF DESCRIPTION OF THE DRAWINGS

FIG. 1 is a representative partially cross-sectional view of an example of a container opener system and associated method which can embody principles of this disclosure.

FIG. 2 is a representative top perspective view of an example of a compliant cutter head that may be used with the FIG. 1 system and method.

FIG. 3 is a representative bottom perspective view of the compliant cutter head.

FIG. 4 is a representative exploded view of the compliant cutter head.

FIGS. 5-7 are representative bottom views of the compliant cutter head with an example of a blade in respective load, safe and extended positions.

FIG. 8 is a representative exploded view of an example of an actuator assembly of the compliant cutter head.

FIG. 9 is a representative exploded view of an example of a blade handling assembly of the container opener system.

FIG. 10 is a representative exploded view of an example of a blade dispenser of the blade handling assembly.

FIG. 11 is a representative exploded top perspective view of an example of a blade magazine and blade guide assembly of the blade dispenser.

FIG. 12 is a representative exploded bottom perspective view of the blade magazine and blade guide assembly.

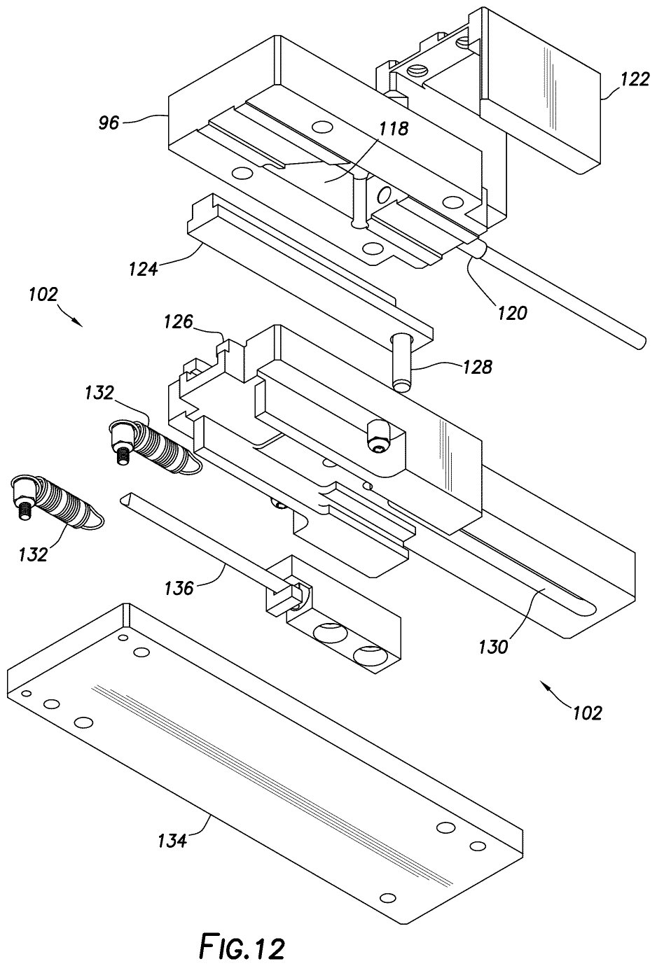

FIG. 13 is a representative cross-sectional view of the container opener system with the compliant cutter head at a blade dispenser station.

FIG. 14 is a representative cross-sectional view of a portion of the compliant cutter head at the blade dispenser station.

FIG. 15 is a representative cross-sectional view of the container opener system with the compliant cutter head at a blade check station.

FIG. 16 is a representative cross-sectional view of a portion of the compliant cutter head at the blade check station.

FIG. 17 is a representative cross-sectional view of the container opener system with the compliant cutter head at a blade discard station.

FIG. 18 is a representative cross-sectional view of a portion of the compliant cutter head at the blade discard station.

FIG. 19 is a representative perspective view of the compliant cutter head as used to cut through tape on a container.

### DETAILED DESCRIPTION

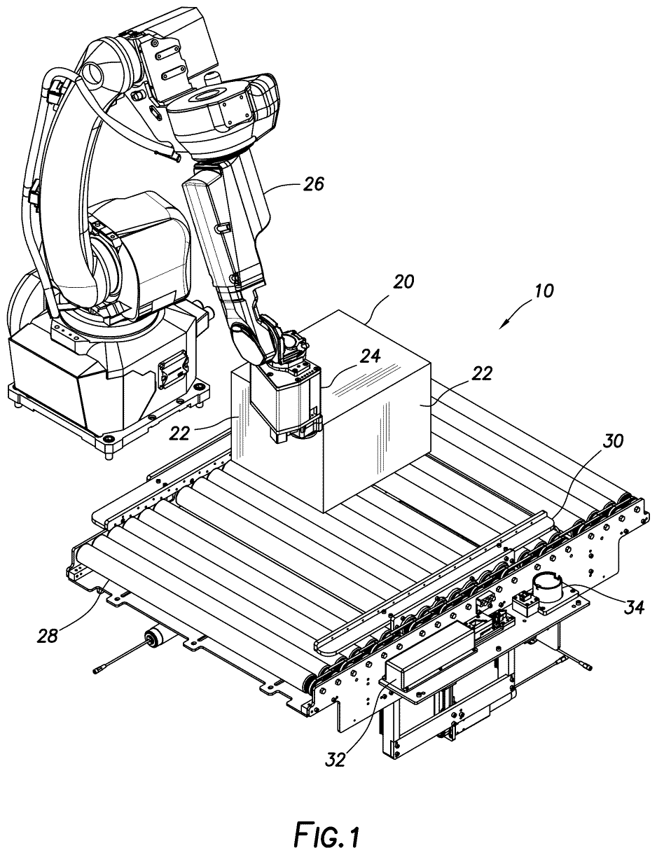

Representatively illustrated in FIG. 1 is a container opener system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, the system 10 is used to cut open a container 20 in the form of a cardboard box having corrugated cardboard walls 22. For this purpose, the system 10 includes a compliant cutter head 24.

In other examples, the container 20 may not include corrugated cardboard walls 22. The container walls 22 in some examples may not be cardboard and/or may not be corrugated. The container walls 22 could be made of a plastic or other material. In still further examples, the system 10 may be used to cut through tape on the container 20 instead of, or in addition to, cutting through the container walls 22. Thus, the scope of this disclosure is not limited to any particular type of container wall or other component that is cut through.

An actuator 26 is used to displace the compliant cutter head 24 relative to the container walls 22, in order to cut through the walls. In this example, the actuator 26 is in the form of a conventional six-axis robotic arm, but in other examples the actuator could comprise a linear actuator, a cartesian coordinate robot, a rotary actuator, or another type of actuator.

In operation, the container 20 is transported to a desired position proximate the cutter head 24 and the actuator 26 by a conveyor 28. A clamp 30 is operated to secure the container 20 in this position while it is being opened.

The system 10 can in some examples include optical sensors, such as LiDAR (light detection and ranging) cameras, to detect the dimensions, positions and orientations of the container walls 22. A suitable system is described in US publication no. 2025/0263192, the entire disclosure of which is incorporated herein by this reference in its entirety for all purposes.

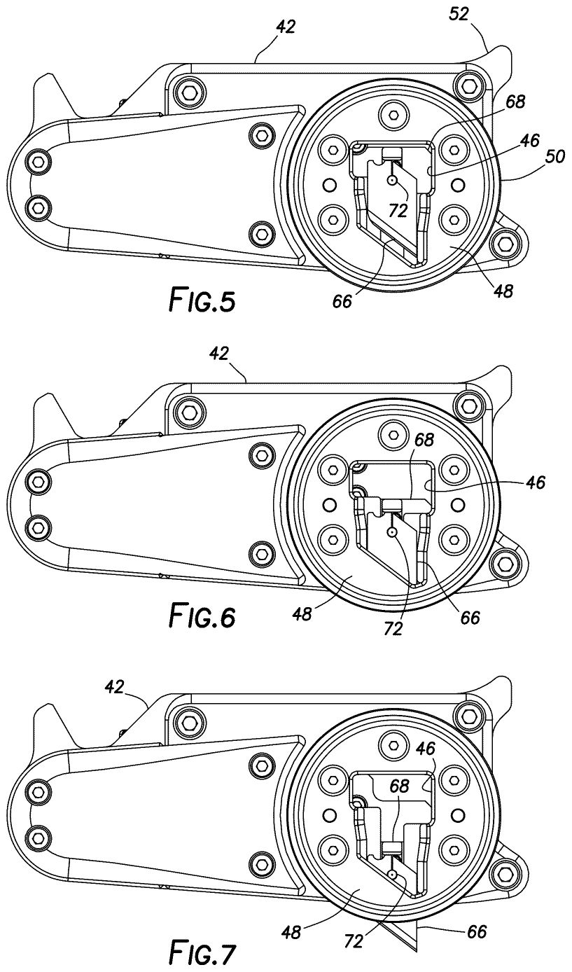

As described more fully below, the cutter head 24 has a blade 66 (not visible in FIG. 1, see FIGS. 5-7) therein that is used to cut through the walls 22 of the container 20. A blade handling assembly 32 dispenses blades 66 one at a time for picking by the cutter head 24. The blade handling assembly 32 also includes a blade receptacle 34 for receiving blades 66 from the cutter head 24 when they are spent.

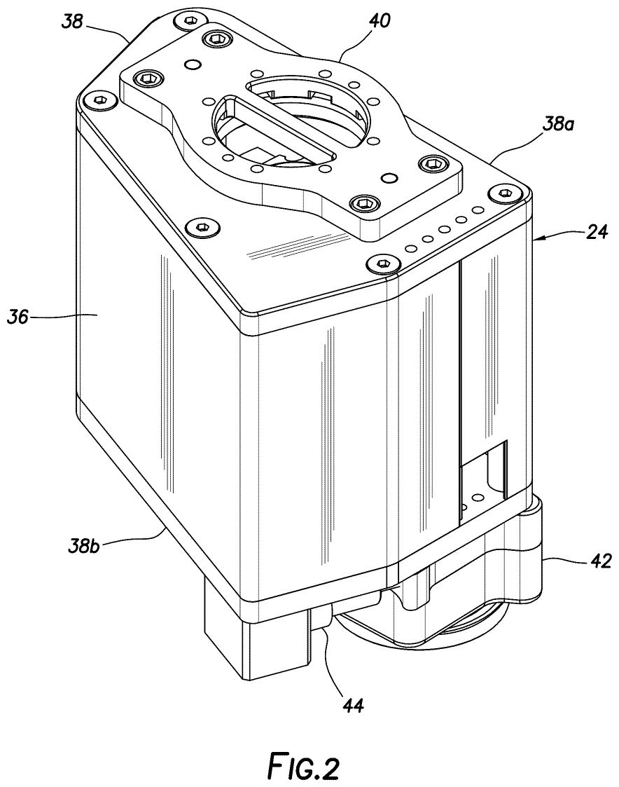

Referring additionally now to FIG. 2, a representative top perspective view of an example of the compliant cutter head 24 is depicted. The FIG. 2 cutter head 24 may be used with the FIG. 1 system 10 and method, or it may be used with other systems and methods. For convenience, the cutter head 24 is described below as it may be used with the FIG. 1 system 10 and method.

As depicted in FIG. 2, the cutter head 24 includes an outer housing assembly 36 that encloses a frame 38. The frame 38 includes spaced apart upper and base plates 38a, b.

An actuator mount 40 is secured to the upper plate 38a. The actuator mount 40 is suitably configured to connect the cutter head 24 to the actuator 26. In some examples, the actuator mount 40 could be integral with the upper plate 38a, instead of being a separate component.

A blade carrier housing assembly 42 extends outward through the base plate 38b. As described more fully below, the housing assembly 42 is pivotable relative to the frame 38 and in operation is biased toward the container 20 by an actuator 44.

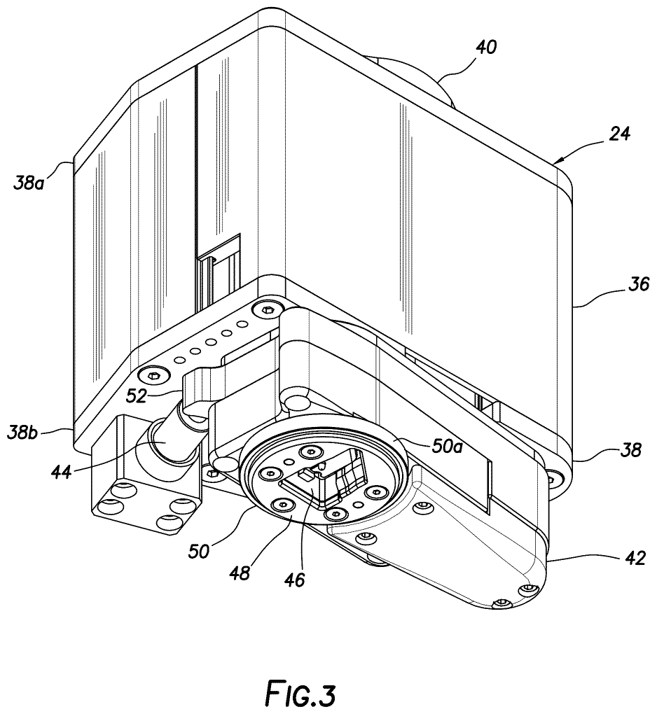

Referring additionally now to FIG. 3, a representative bottom perspective view of the compliant cutter head 24 is depicted. In this view it may be seen that a blade opening 46 is formed in a retainer assembly 48 of the cutter head 24.

Blades 66 (one at a time) are received into the cutter head 24 from the blade handling assembly 32 via the opening 46 and, when the blades are spent, they are expelled via the opening into the receptacle 34. The retainer assembly 48 is also used to retain a radial bearing 50 on the housing assembly 42 for rolling contact with the container walls 22 when the walls are being cut through. In the FIG. 3 example, the actuator 44 applies a resilient biasing force to a projection 52 extending outward from the housing assembly 42. The biasing force maintains an outer race 50a of the radial bearing 50 in contact with a container wall 22 as the blade 66 cuts through the wall. In operation, the actuator 44 biases the housing assembly 42 to rotate in one rotational direction relative to the frame 38, and displacement of the cutter head 24 into contact with a container wall 22 deflects the housing assembly relative to the frame in an opposite rotational direction.

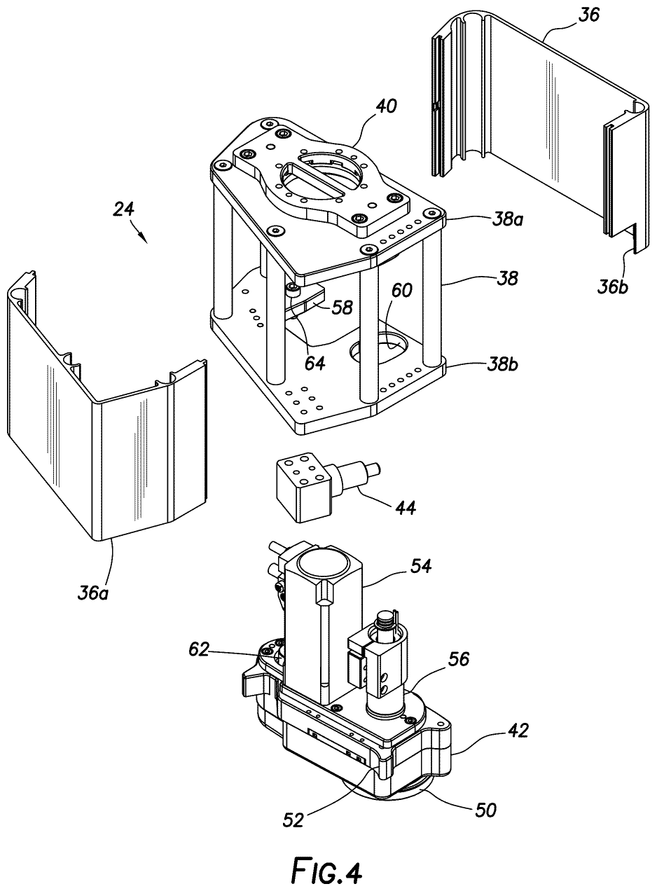

Referring additionally now to FIG. 4, a representative exploded view of the compliant cutter head 24 is depicted. In this view, the manner in which the outer housing assembly 36 encloses sides of the frame 38 can be seen. In this example, the outer housing assembly 36 includes two sections 36a, b.

Actuators 54, 56 are mounted to the housing assembly 42. The actuator 54 is used to selectively extend and retract the blade 66. The actuator 56 is used to expel the blade 66 when it is spent.

The actuators 54, 56 extend through the base plate 38b via openings 58, 60. The openings 58, 60 accommodate pivoting of the actuators 54, 56 and the housing assembly 42 about a pivot 62 secured to the base plate 38b (such as, using a fastener 64).

Referring additionally now to FIGS. 5-7, representative bottom views of the compliant cutter head 24 with an example of a blade 66 in respective load, safe and extended positions are depicted. The actuator 54 displaces the blade 66 and a blade carrier 68 relative to the housing assembly 42, so that the blade is selectively retracted into, or extended outward from, the housing assembly.

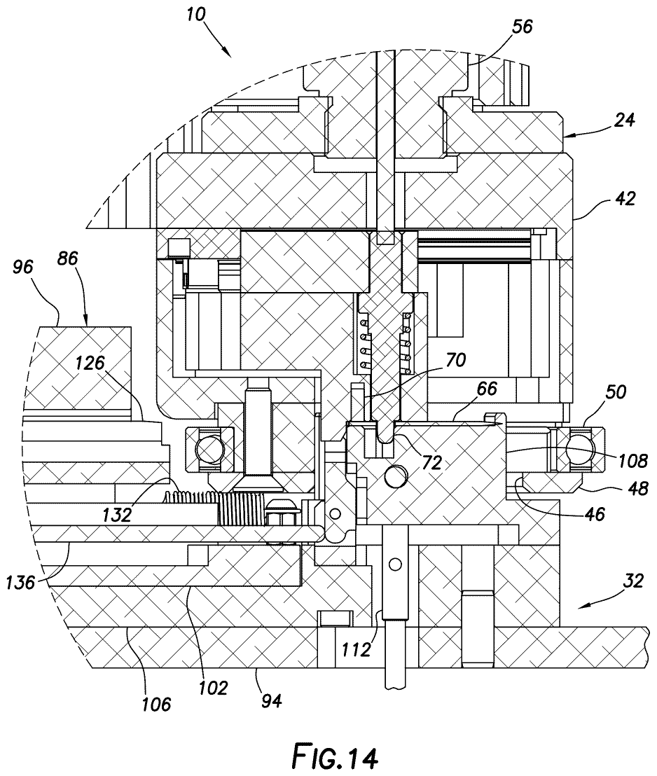

As depicted in FIG. 5, the blade 66 is in the load position, in which the blade can be received or expelled via the blade opening 46. In this load position, the retainer assembly 48 does not retain the blade 66. Instead, only a magnet 70 (not visible in FIG. 5, see FIG. 14) holds the blade 66 on the blade carrier 68.

Note that a pin 72 of the blade carrier 68 is received in the blade 66.

As depicted in FIG. 6, the blade 66 is in the safe position, in which the blade is prevented by the retainer assembly 48 from being displaced through the opening 46. The blade 66 is displaced to the safe position by the actuator 54 at any time it is desired that the blade 66 be retained in the cutter head 24, but it is not desired for the blade to extend outward from the housing assembly 42.

As depicted in FIG. 7, the blade 66 is in the extended position, in which the blade extends outward from the housing assembly 42. The blade 66 is still prevented by the retainer assembly 48 from being displaced through the opening 46 in the extended position. The blade 66 is displaced to the extended position by the actuator 54 when it is desired to cut through a container wall 22.

The actuator 54 can vary the distance that the blade 66 extends outward to correspond to a thickness of the container wall 22. For example, the actuator 54 could extend the blade 66 outward a distance that is somewhat greater than the thickness of the container wall 22.

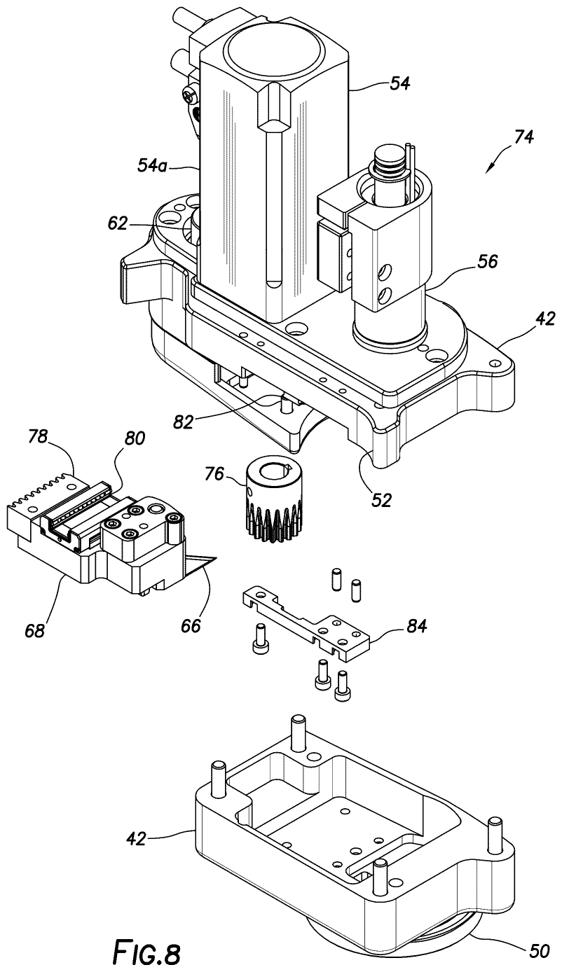

Referring additionally now to FIG. 8, a representative exploded view of an example of an actuator assembly 74 of the compliant cutter head 24 is depicted. The actuator assembly 74 in this example includes at least the actuators 54, 56, the housing assembly 42, the radial bearing 50 and the blade carrier 68.

A pinion gear 76 is secured to a shaft (not visible in FIG. 8) of the actuator 54, so that the pinion gear is rotatable by the actuator. In this example the actuator 54 comprises a servo motor 54a, so that the pinion gear 76 can be rotated in discrete increments to desired rotational positions corresponding to desired displacements of the blade carrier 68 and blade 66.

A toothed rack 78 is secured to the blade carrier 68. The pinion gear 76 is engaged with the rack 78, so that a certain rotational displacement of the pinion gear by the actuator 54 corresponds to a certain linear displacement of the blade carrier 68 and the blade 66.

A linear guide 80 attached to the blade carrier 68 engages a rail 82 in the housing assembly 42 and ensures that the blade carrier displaces in a desired direction when the pinion gear 76 is rotated by the actuator 54. A stop plate 84 limits the displacement of the blade carrier 68 relative to the housing assembly 42.

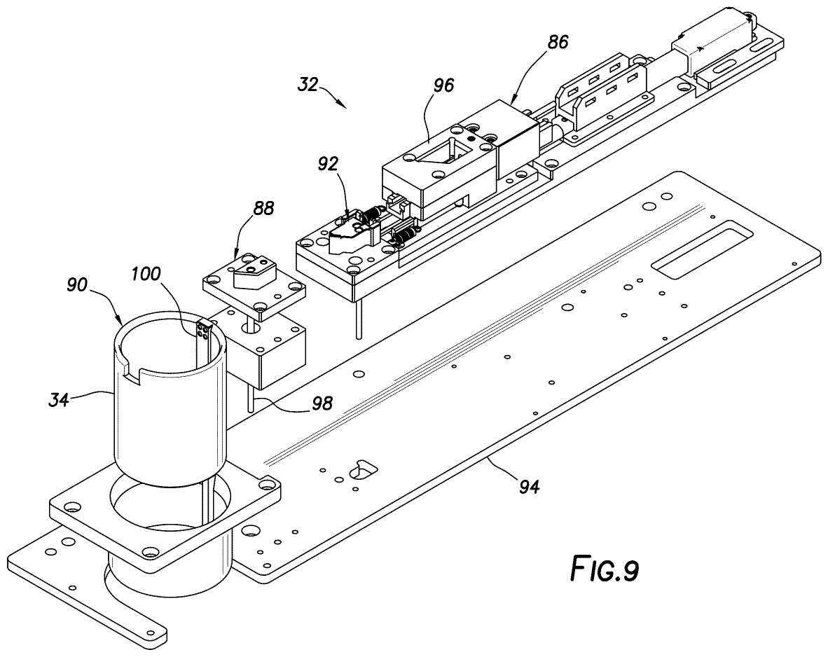

Referring additionally now to FIG. 9, a representative exploded view of an example of the blade handling assembly 32 of the container opener system 10 is depicted. In this example, the blade handling assembly 32 includes a blade dispenser 86 with a blade dispense station 92, a blade check station 88 and a blade discard station 90 mounted on a base plate 94.

The blade dispenser 86 dispenses blades 66 one at a time from a blade magazine 96. A dispensed blade 66 is presented for picking by the cutter head 24 at the blade dispense station 92.

In some examples, multiple blades 66 may be provided in a cartridge (not shown). A tool may be used to push the blades 66 out of the cartridge and into the magazine 96, without any need for an operator to touch any blade(s).

The blade check station 88 is used to verify whether a blade 66 is present in the cutter head 24. The blade check station 88 includes a sensor 98 for detecting the presence of a blade 66 in the cutter head 24, or the absence of the blade in the cutter head.

The blade discard station 90 includes the blade receptacle 34 for receiving a blade 66 expelled from the cutter head 24. A level sensor 100 detects a height of blades 66 accumulated in the receptacle 90.

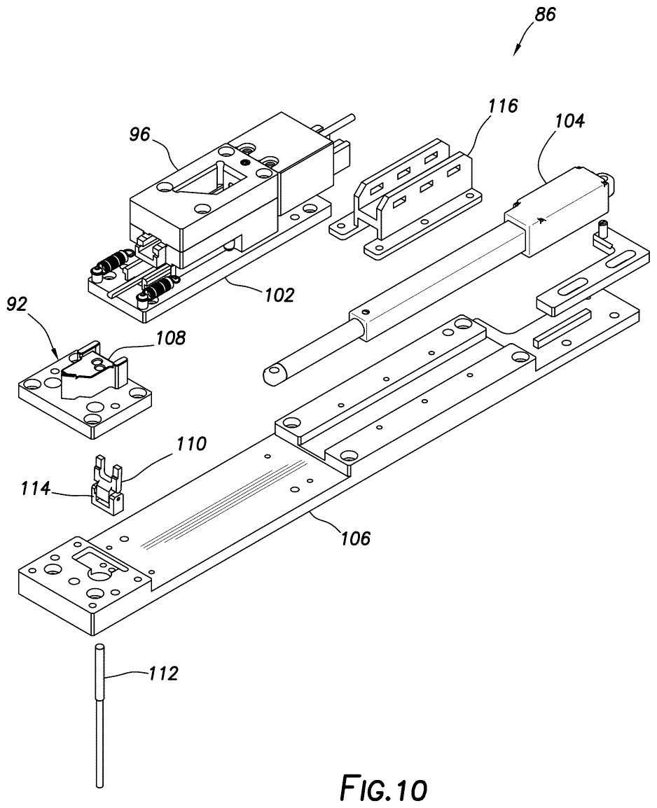

Referring additionally now to FIG. 10, a representative exploded view of an example of the blade dispenser 86 is depicted. The blade dispenser 86 in this example includes the blade magazine 96, a blade guide assembly 102, an actuator 104 and the blade dispense station 92 mounted to a base plate 106.

The blade guide assembly 102 receives blades 66 from the blade magazine 96 and one at a time displaces a blade to a blade nest 108 of the blade dispense station 92. The actuator 104 is used to operate the blade guide assembly 102. In this example, the actuator 104 is a linear actuator, such as, an electrical screw-type actuator, but in other examples a pneumatic, hydraulic or other type of actuator may be used.

The blade dispense station 92 includes the blade nest 108, a blade retainer 114 and a sensor 112. The sensor 112 detects whether a blade 66 is present in the blade nest 108. The sensor 112 may be the same as or similar to the sensor 98 of the blade check station 88.

The blade retainer 114 includes a spring biased pivotable arm 110 for retaining a blade in the blade nest 108 after the blade has been displaced to the blade nest by the blade guide assembly 102 and actuator 104. An actuator mount 116 is used to secure the actuator 104 on the base plate 106.

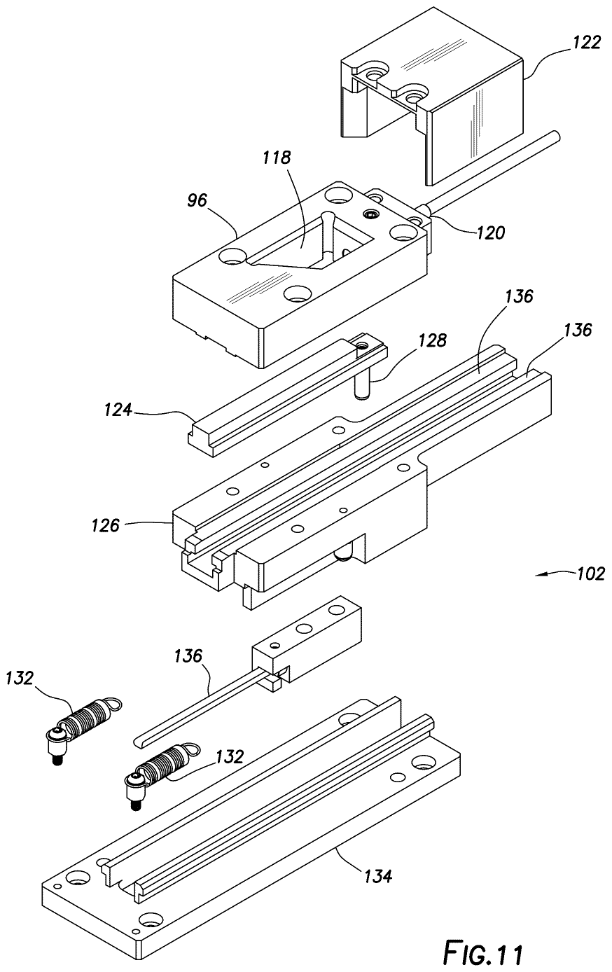

Referring additionally now to FIGS. 11 & 12, representative exploded top and bottom perspective views of an example of the blade magazine 96 and blade guide assembly 102 are depicted. In these views, the manner in which the blade guide assembly 102 is operative to dispense blades 66 one at a time from the blade magazine 96 can be seen.

The blade magazine 96 includes an opening 118 for receiving a stack of blades 66 therein. A sensor 120 detects whether the blades 66 are present in the opening 118. A housing 122 encloses and protects the sensor 120.

The blade guide assembly 102 includes a blade push arm 124 displaceable relative to a blade guide 126 by the actuator 104. The blade push arm 124 and blade guide 126 are positioned relative to the blade magazine 96 so that the blade push arm will engage an end of a single blade 66 extending downwardly through the opening 118. The actuator 104 will displace the blade push arm 124 and the single blade 66 along the blade guide 126, so that the blade is displaced onto the blade nest 108.

In this example, the blade push arm 124 is connected to the actuator 104 with a pin 128 that extends through a slot 130 formed through the blade guide 126. The blade guide 126 is biased toward the blade nest 108 by springs 132 extending between the blade guide and a base guide plate 134.

To dispense a blade 66 from the magazine 96, the actuator 104 is operated to pull the blade push arm 124 away from the blade nest 108.

Eventually, the pin 128 will contact an end of the slot 130, and then the actuator 104 will pull both the blade push arm 124 and the blade guide 126 away from the blade nest 108 against the biasing forces exerted by the springs 132.

As the blade push arm 124 is pulled away from the blade nest 108 by the actuator 104, eventually the blade push arm 124 will no longer underlie the stack of blades 66 in the opening 118 of the magazine 96. This will allow the stack of blades 66 to drop downward in the opening 118, until a lowermost one of the blades 66 rests on guide faces 136 of the blade guide 126.

The actuator 104 is then operated to displace the blade push arm 124 toward the blade nest 108. The blade push arm 124 contacts the lowermost blade 66 resting on the guide faces 136, and so the blade is displaced by the blade push arm toward the blade nest 108.

The blade guide 126 is initially displaced with the blade push arm 124 by the springs 132. However, eventually the blade guide 126 abuts the blade nest 108 and ceases displacing toward the blade nest.

The blade push arm 12 continues to be displaced by the actuator 104 toward the blade nest 108, until the blade 66 is received in the blade nest. The pin 128 is displaced through the slot 130 when the actuator 104 displaces the blade push arm 124 relative to the blade guide 126 and toward the blade nest 108.

A retainer push arm 136 is secured to the blade guide 126, so that the retainer push arm displaces with the blade guide 126. The retainer push arm 136 is used to pivot the arm 110 of the blade retainer 114 (see FIG. 10), so that the arm is pivoted away from the blade nest 108 when the blade guide 126 is displaced toward the blade nest, and the arm is pivoted toward the blade nest to retain the blade 66 therein when the blade guide is displaced away from the blade nest.

The actuator 104 is then operated to displace the blade push arm 124 and blade guide 126 away from the blade nest 108. The cutter head 24 can then be displaced by the actuator 26 to the blade dispense station 92 to pick the blade 66 from the blade nest 108.

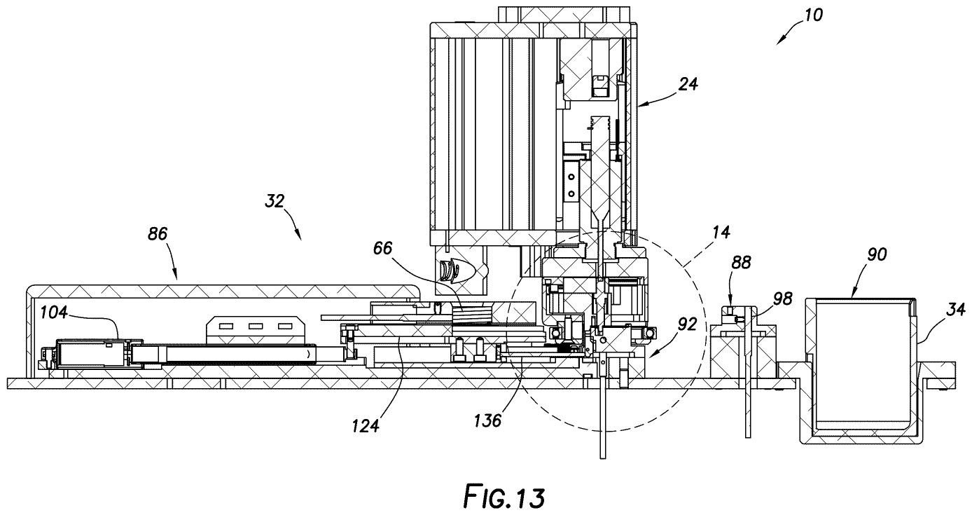

Referring additionally now to FIGS. 13 & 14, representative cross-sectional and detail views of the container opener system 10 with the compliant cutter head 24 at the blade dispenser station 92 are depicted. The FIG. 14 detail view is designated as detail 14 in FIG. 13.

In these views it may be seen that the actuator 26 has displaced the cutter head 24 to the blade dispense station 92, where a blade 66 has been dispensed onto the blade nest 108 by the blade dispenser 86 as described above. The blade nest 108, with the blade 66 therein, is received in the opening 46 in the retainer assembly 48. In some examples, this operation may not be performed if the sensor 112 does not detect the presence of the blade 66 in the blade nest 108.

The pin 72 is inserted in the blade 66 when the blade nest 108 is received in the retainer assembly 48. The magnet 70 magnetically attracts the blade 66 toward the blade carrier 68 so that, when the cutter head 24 is displaced by the actuator 26 away from the blade nest 108, the blade displaces with the cutter head. Note that the blade 66 is in the load position of FIG. 5 at this point.

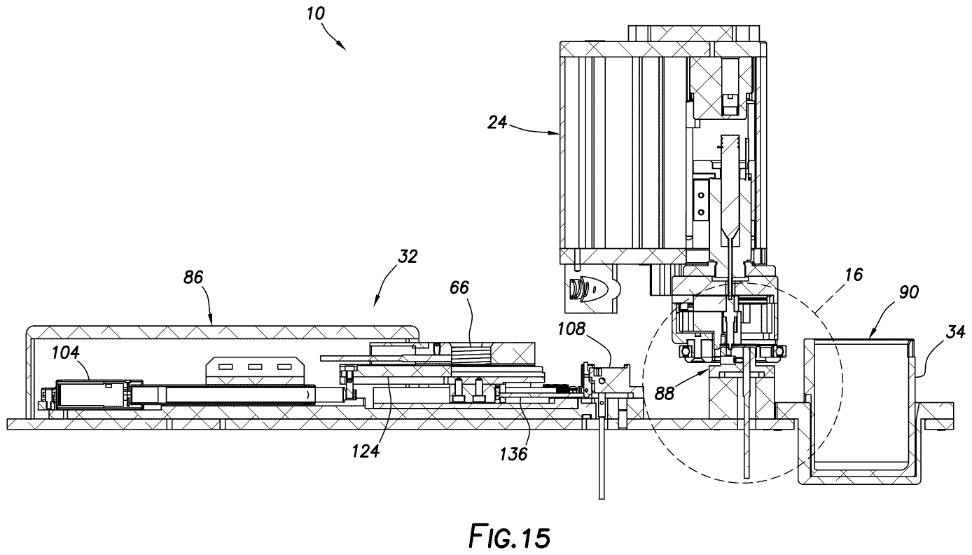

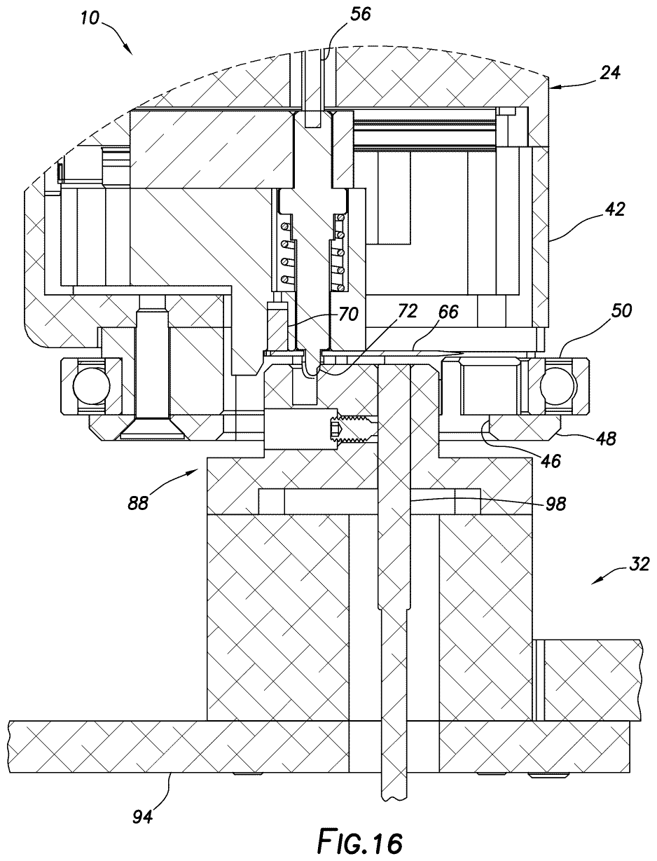

Referring additionally now to FIGS. 15 & 16 representative cross-sectional and detail views of the container opener system 10 with the compliant cutter head 24 at the blade check station 88 are depicted. The FIG. 16 detail view is designated as detail 16 in FIG. 15.

In these views it may be seen that the actuator 26 has displaced the cutter head 24 to the blade check station 88. The cutter head 24 can be displaced to the blade check station 88 after the cutter head has picked a blade 66 from the blade nest 108 of the blade dispense station 92 (in order to confirm whether a blade has indeed been properly picked from the blade nest), and the cutter head can be displaced to the blade check station after a blade has been expelled from the cutter head (in order to confirm that the blade has indeed been properly expelled from the cutter head).

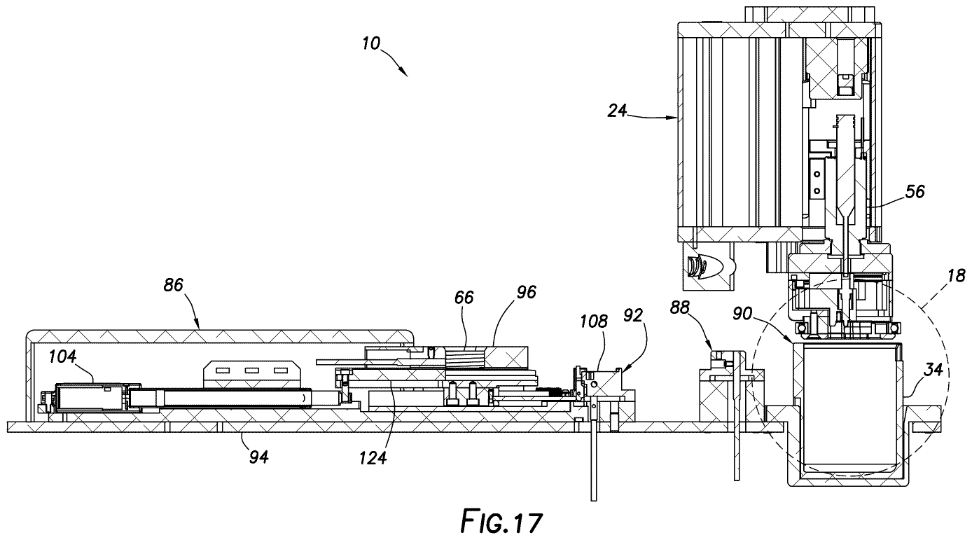

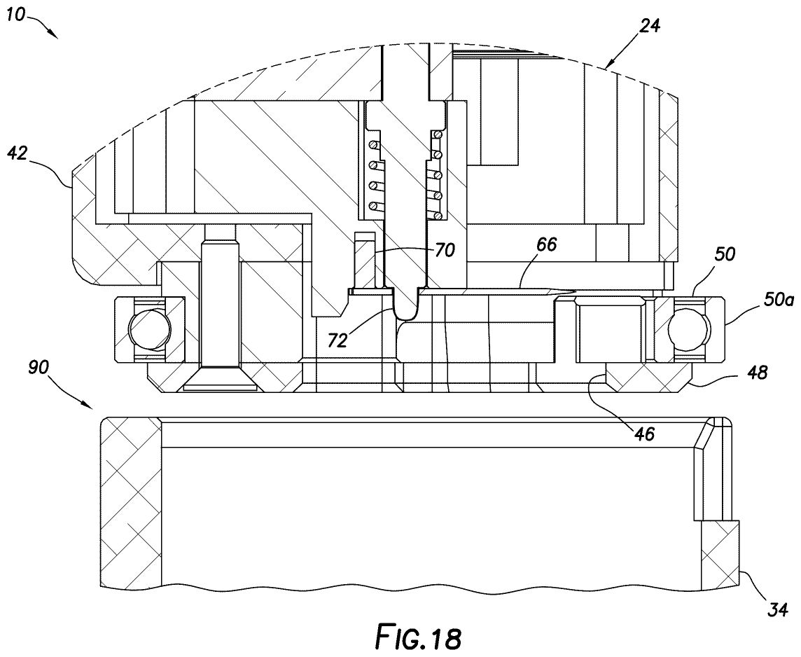

The sensor 98 is received in the opening 46 to detect whether the blade 66 is present in the cutter head 24. In some examples, the container 20 opening operation may be ceased and a notification or alarm generated if a blade 66 is not properly present in the cutter head 24 (when the cutter head is displaced to the blade check station 88 from the blade dispense station 92), or properly absent from the cutter head (when the cutter head 24 is displaced to the blade check station 88 from the blade discard station 90), at the blade check station 88. Referring additionally now to FIGS. 17 & 18, representative cross-sectional and detail views of the container opener system 10 with the compliant cutter head 24 at the blade discard station 90 are depicted. The FIG. 18 detail view is designated as detail 18 in FIG. 17.

In these views it may be seen that the actuator 26 has displaced the cutter head 24 to the blade discard station 90. The cutter head 24 is displaced to the blade discard station 90 when the blade 66 in the cutter head is spent (e.g., dull or damaged, so that it's cutting efficiency is reduced).

At the blade discard station 90, the cutter head 24 is positioned over the blade receptacle 34. Then the actuator 56 is operated to cause the pin 72 to displace downward. This displaces the blade 66 downward and away from the magnet 70, so that the blade can drop into the receptacle.

The actuator 56 in this example comprises a solenoid-type actuator. In other examples, other types of actuators may be used.

After the blade 66 is expelled through the opening 46 and into the receptacle 34, the actuator 26 can displace the cutter head 24 to the blade check station 88, in order to verify whether the blade has been discharged from the cutter head. Then, the cutter head 24 can be displaced to the blade dispense station 92 to pick another blade 66.

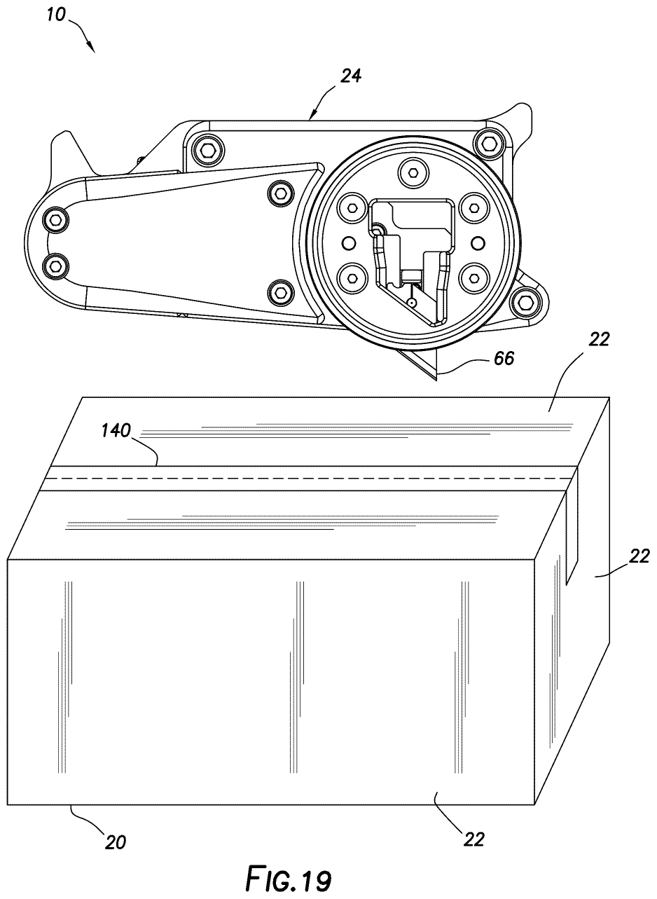

Referring additionally now to FIG. 19, a representative perspective view of the compliant cutter head 24 as used to cut through tape 140 on the container 20 is depicted. In this example, the blade 66 of the compliant cutter head 24 may not cut through the container walls 22 in addition to cutting through the tape.

Optical sensors, such as LiDAR (light detection and ranging) cameras, may be used to detect the dimensions, positions and orientations of the tape 140 on the container 20, for example, using the system is described in the US publication no. 2025/0263192. The blade 66 can cut through the tape 140 on multiple walls 22 of the container 20 (such as, the top, bottom or side walls). Preferably, the blade 66 will cut through the tape 140 at a seam between panels of the walls 22 (such as, between the top and side walls of the container 20, and between individual panels of the top wall).

Thus, the walls 22 and the tape 140 are examples of components of the container 20 that can be cut through using the system 10. The scope of this disclosure is not limited to cutting through any particular component of the container 20.

It may now be fully appreciated that the present disclosure provides significant advancements to the art of constructing and operating container opener systems. In an example described herein, the blade 66 can be extended a desired distance outwardly from the cutter head 24, and the amount of exposed blade can be varied by operation of the actuator 54. The blade 66 and a radial bearing 50 are resiliently biased into contact with the container wall 22, the tape 140 or another component of the container as the blade cuts through the container component.

The present disclosure provides to the art a container opener system 10 for cutting through a component (e.g., the wall 22 or tape 140) of a container 20. In one example, the container opener system 10 can comprise: a cutter head 24 comprising a first actuator 54 configured to selectively extend and retract a blade 66, and a second actuator 44 configured to resiliently bias the cutter head 24 into contact with the container component; and an actuator mount 40 configured to connect the cutter head 24 to a third actuator 26.

The first actuator 54 may include a motor 54a and a pinion gear 76. The pinion gear 76 may engage a rack 78 of a blade carrier 68 configured to hold the blade 66 in the cutter head 24.

The blade carrier 68 may include a magnet 70 configured to magnetically attract the blade 66.

The second actuator 44 may include a spring, an elastomer or another structure capable of exerting a resilient biasing force. The third actuator 26 may comprise a six-axis robot.

The actuator mount 40 may be secured to a frame 38 of the cutter head 24. The first actuator 54 may be pivotable relative to the frame 38. The second actuator 44 may bias the first actuator 54 and the blade 66 to pivot relative to the frame 38.

The cutter head 24 may include a retainer assembly 48 configured to secure a radial bearing 50 to a housing 42 of the cutter head 24. An outer race 50a of the radial bearing 50 may be configured to contact the container component as the blade 66 cuts through the container component.

The retainer assembly 48 may retain the blade 66 in safe and extended positions of the blade 66. The safe position is a position in which the blade 66 is retained by the retainer assembly 48 but the blade 66 is not extended. The extended position is a position in which the blade 66 extends at least partially outward from the cutter head 24.

The retainer assembly 48 does not retain the blade 66 in a load position of the blade 66. The load position is a position in which the blade 66 is not extended outward from the cutter head 24.

The cutter head 24 may include a fourth actuator 56 configured to eject the blade 66 from the cutter head 24 through an opening 46 in the retainer assembly 48.

A method of cutting through a component (e.g., the wall 22 or tape 140) of a container 20 is also disclosed herein. In one example, the method can comprise: mounting a cutter head 24 for displacement relative to the container 20, the cutter head 24 comprising a first actuator 54 that selectively extends and retracts a blade 66; operating the first actuator 54, thereby extending the blade 66 outward from the cutter head 24; and displacing the cutter head 24 along the component of the container 20, thereby cutting through the component. A second actuator 44 of the cutter head 24 resiliently biases the blade 66 toward the component during the cutting.

The operating step may include the first actuator 54 rotating a pinion gear 76 engaged with a rack 78 of a blade carrier 68 that holds the blade 66 in the cutter head 24.

The displacing step may include rotating a radial bearing 50 of the cutter head 24 as the second actuator 44 biases the radial bearing 50 toward the component of the container 20.

The mounting step may include connecting an actuator mount 40 between the cutter head 24 and a third actuator 26. The displacing step may include the third actuator 26 displacing the cutter head 24 along the component of the container 20.

The method may include displacing the cutter head 24 to a blade dispenser station 92, dispensing the blade 66 from the blade dispenser station 92, and receiving the blade 66 in the cutter head 24. The dispensing step may include discharging the blade 66 from a blade magazine 96. The receiving step may include a magnet 70 of a blade carrier 68 of the cutter head 24 magnetically attracting the blade 66.

The method may include displacing the cutter head 24 to a blade check station 88, and a sensor 98 at the blade check station 88 sensing whether the blade 66 is present in the cutter head 24. The method may include displacing the cutter head 24 to a blade discard station 90, and a third actuator 56 of the cutter head 24 expelling the blade 66 from the cutter head 24.

The cutting step may include cutting through a wall 22 of, and/or a tape 140 on, the container 20.

A blade handling assembly 32 is also provided to the art by the present disclosure. In one example, the blade handling assembly 32 can comprise: a blade dispenser 86 including an actuator 104, a blade guide assembly 102, and a blade magazine 96 containing multiple blades 66. The blade guide assembly 102 is configured to discharge one of the blades 66 from the blade magazine 96 in response to actuation of the actuator 104.

The blade guide assembly 102 may include a blade push arm 124 displaceable by the actuator 104 relative to a blade guide 126. The blade guide 126 may be configured to receive the one of the blades 66 from the blade magazine 96. The blade push arm 124 may be configured to displace the one of the blades 66 along the blade guide 126 in response to the actuation of the actuator 104.

The blade guide 126 may be displaceable by the actuator 104 to a receiving position in which the blade guide 126 receives the one of the blades 66 from the blade magazine 96. The blade guide 126 may be displaceable to a presenting position proximate a blade nest 108. The blade push arm 124 may be configured to discharge the one of the blades 66 from the blade guide 126 to the blade nest 108.

The blade handling assembly 32 may include a blade check station 88. The blade check station 88 may include a blade sensor 98 configured to sense whether a blade 66 is proximate the blade sensor 98.

The blade handling assembly 32 may include a blade discard station 90. The blade discard station 90 may include a blade receptacle 34 configured to receive a blade 66 expelled from a cutter head 24.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A container opener system for cutting through a component of a container, the container opener system comprising:
a cutter head comprising a first actuator configured to selectively extend and retract a blade, and a second actuator configured to resiliently bias the cutter head into contact with the container component; and
an actuator mount configured to connect the cutter head to a third actuator.

2. The container opener system of claim 1, in which the first actuator comprises a motor and a pinion gear, and in which the pinion gear engages a rack of a blade carrier configured to hold the blade in the cutter head.

3. The container opener system of claim 2, in which the blade carrier comprises a magnet configured to magnetically attract the blade.

4. The container opener system of claim 1, in which the third actuator comprises a six-axis robot.

5. The container opener system of claim 1, in which the actuator mount is secured to a frame of the cutter head, and in which the first actuator is pivotable relative to the frame.

6. The container opener system of claim 5, in which the second actuator biases the first actuator and the blade to pivot relative to the frame.

7. The container opener system of claim 1, in which the cutter head comprises a retainer assembly configured to secure a radial bearing to a housing of the cutter head, an outer race of the radial bearing being configured to contact the container component as the blade cuts through the container component.

8. The container opener system of claim 7, in which the retainer assembly retains the blade in safe and extended positions of the blade, in which the safe position is a position in which the blade is retained by the retainer assembly but the blade is not extended, and in which the extended position is a position in which the blade extends at least partially outward from the cutter head.

9. The container opener system of claim 8, in which the retainer assembly does not retain the blade in a load position of the blade, and in which the load position is a position in which the blade is not extended outward from the cutter head.

10. The container opener system of claim 7, in which the cutter head comprises a fourth actuator configured to eject the blade from the cutter head through an opening in the retainer assembly.

11. A method of cutting through a component of a container, the method comprising:
mounting a cutter head for displacement relative to the container, the cutter head comprising a first actuator that selectively extends and retracts a blade;
operating the first actuator, thereby extending the blade outward from the cutter head; and
displacing the cutter head along the component of the container, thereby cutting through the component, in which a second actuator of the cutter head resiliently biases the blade toward the component during the cutting.

12. The method of claim 11, in which the operating comprises the first actuator rotating a pinion gear engaged with a rack of a blade carrier that holds the blade in the cutter head.

13. The method of claim 11, in which the displacing comprises rotating a radial bearing of the cutter head as the second actuator biases the radial bearing toward the component of the container.

14. The method of claim 11, in which the mounting comprises connecting an actuator mount between the cutter head and a third actuator, and in which the displacing comprises the third actuator displacing the cutter head along the component of the container.

15. The method of claim 11, further comprising displacing the cutter head to a blade dispenser station, dispensing the blade from the blade dispenser station, and receiving the blade in the cutter head.

16. The method of claim 15, in which the dispensing comprises discharging the blade from a blade magazine.

17. The method of claim 15, in which the receiving comprises a magnet of a blade carrier of the cutter head magnetically attracting the blade.

18. The method of claim 15, further comprising displacing the cutter head to a blade check station, and a sensor at the blade check station sensing whether the blade is present in the cutter head.

19. The method of claim 15, further comprising displacing the cutter head to a blade discard station, and a third actuator of the cutter head expelling the blade from the cutter head.

20. The method of claim 11, in which in the cutting, the component comprises a wall of the container.

21. The method of claim 11, in which in the cutting, the component comprises tape on the container.

22. A blade handling assembly, comprising:
a blade dispenser comprising:
an actuator,
a blade guide assembly, and
a blade magazine containing multiple blades,
in which the blade guide assembly is configured to discharge one of the blades from the blade magazine in response to actuation of the actuator.

23. The blade handling assembly of claim 22, in which the blade guide assembly comprises a blade push arm displaceable by the actuator relative to a blade guide.

24. The blade handling assembly of claim 23, in which the blade guide is configured to receive the one of the blades from the blade magazine, and in which the blade push arm is configured to displace the one of the blades along the blade guide in response to the actuation of the actuator.

25. The blade handling assembly of claim 24, in which the blade guide is displaceable by the actuator to a receiving position in which the blade guide receives the one of the blades from the blade magazine, and in which the blade guide is displaceable to a presenting position proximate a blade nest.

26. The blade handling assembly of claim 25, in which the blade push arm is configured to discharge the one of the blades from the blade guide to the blade nest.

27. The blade handling assembly of claim 22, further comprising a blade check station, the blade check station comprising a blade sensor configured to sense whether a blade is proximate the blade sensor.

28. The blade handling assembly of claim 22, further comprising a blade discard station, the blade discard station comprising a blade receptacle configured to receive a blade expelled from a cutter head.
